(19) United States
(12) Patent Application Publication
(10) Pub. No.: US 2008/0006149 A1
(43) Pub. Date: Jan. 10, 2008

(54) Compressor

(76) Inventors: Takayuki Kato, Kariya-shi (JP); Fuminobu Enokijima, Kariya-shi (JP); Masaki Inoue, Kariya-shi (JP); Hajime Ikuno, Seto-shi (JP); Akira Yamada, Kariya-shi (JP); Hiroshi Hohjo, Nagoya-shi (JP); Hiroshi Kawahara, Nagoya-shi (JP); Shoji Hotta, Obu-shi (JP); Isamu Ueda, Kasugai-shi (JP)

Correspondence Address: MORGAN & FINNEGAN, L.L.P., 3 World Financial Center, New York, NY, 10281-2101, US

(21) Appl. No.: 11/824,858

(22) Filed: Jul. 3, 2007

(30) Foreign Application Priority Data
Jul. 3, 2006 (JP) 2006-183918

(51) Int. Cl. F02F 7/00

(52) U.S. Cl. 92/261

(57) ABSTRACT

A compressor having a housing formed by a plurality of housing members that are connected together is disclosed. The compressor is configured in such a manner that refrigerant is compressed in the housing and discharged to the exterior. Each of the housing members contains 9 to 17 percent by mass of Si, 3.5 to 6 percent by mass of Cu, 0.2 to 1.2 percent by mass of Mg, 0.2 to 1.5 percent by mass of Fe, 0 to 1 percent by mass of Mn, 0.5 percent by mass or less of Ni, and a remaining portion containing Al and unavoidable impurities. It is preferred that the average hardness of each housing member is adjusted to HV130 to HV170 through solution heating in which the housing member is maintained at the treatment temperature of 450° C. to 510° C. for 0.5 hours or longer, followed by water quenching, and then by aging treatment in which the housing member is maintained at the treatment temperature of 170° C. to 230° C. for one to twenty-four hours after the c housing member is cast.

### BACKGROUND OF THE INVENTION

The present invention relates to a compressor having a housing that is formed of an aluminum alloy and exhibits an improved relaxation resistance.

Apparatuses such as air conditioners employ a compressor to compress refrigerant and discharge the refrigerant under high pressure. As such compressors, there are, for example, swash-plate type compressors. A compressor includes a housing and components that rotate or slide in the housing.

In many cases, a compressor mounted in, for example, a vehicle includes a housing formed not of steel, but of cast aluminum alloy to reduce the weight of the compressor.

To form a compressor housing, a plurality of housing members are combined and connected together. Since the pressure in the housing rises when the compressor operates, connecting portions of the housing members must be sealed with an improved tightness. The compressor thus employs a fastening structure that applies great contact force to the connecting portions.

If aluminum alloy is maintained in a distorted state, distortion causes stress. Such stress decreases as the time elapses through stress relaxation. If a material that easily causes such stress relaxation is used to form a housing of a compressor, the stress produced in the connecting portions of the housing members may become gradually relaxed and thus lower the sealing performance of the connecting portions. Accordingly, it is preferred that the cast aluminum alloy forming a compressor housing exhibit an improved relaxation resistance.

Although heat resistance of some of conventionally known Al—Si type cast aluminum alloys have been evaluated, there are substantially no disclosures of such alloys which have been evaluated in terms of relaxation resistance.

For example, Japanese Laid-Open Patent Publication No. 2004-76110 describes a technique that employs a hypereutectic Al—Si alloy with enhanced heat resistance as cast aluminum alloy for forming pistons. Further, “Casting and Solidification” (published on Jan. 20, 1992 by the Japan Institute of Metals) discloses a hypoeutectic Al—Si alloy with improved ductility and toughness.

The aforementioned patent document, Japanese Laid-Open Patent Publication No. 2004-76110, discloses a cast aluminum alloy containing 1.8 to 3% by mass of Ni. As in this case, Ni may be added to a conventional aluminum alloy to improve the heat resistance of the alloy. However, since Ni is expensive, it is desired that the content of Ni be minimized. Further, the effect of Ni on improvement of the relaxation resistance of the cast aluminum alloy, which is the goal of the present invention, is unknown. The aluminum alloy descried in this patent document is a hypereutectic structure of Al—Si.

The aforementioned document “Casting and Solidification” suggests that Sr, Na, or Sb may be added to hypoeutectic Al—Si alloy to fine eutectic Si. That is, as described in this document, eutectic Si is fined to improve ductility and toughness of alloy. However, since such ductility and toughness decrease as the content of Cu increases, the content of Cu must be low to ensure improvement of the ductility and toughness of the alloy.

### SUMMARY OF THE INVENTION

Accordingly, it is an objective of the present invention to provide a compressor exhibiting an improved relaxation resistance by employing a cast aluminum alloy with an improved relaxation resistance in at least a portion of a housing.

To achieve the foregoing objective and in accordance with one aspect of the present invention, a compressor having a housing formed by a plurality of housing members each formed of an aluminum alloy is provided. The compressor is configured in such a manner that a refrigerant is compressed in the housing and discharged to the exterior. At least one of the housing members is formed of a cast aluminum alloy with an improved relaxation resistance. The cast aluminum alloy contain 9 to 17 percent by mass of Si, 3.5 to 6 percent by mass of Cu, 0.2 to 1.2 percent by mass of Mg, 0.2 to 1.5 percent by mass of Fe, 0 to 1 percent by mass of Mn, 0.5 percent by mass or less of Ni, and a remaining portion containing Al and unavoidable impurities.

In accordance with another aspect of the present invention, a compressor having a housing formed by a plurality of housing members each formed of an aluminum alloy is provided. The compressor is configured in such a manner that a refrigerant is compressed in the housing and discharged to the exterior. At least one of the housing members is formed of a cast aluminum alloy with an improved relaxation resistance. The cast aluminum contain 9 to 17 percent by mass of Si, 3.5 to 6 percent by mass of Cu, 0.3 to 1.2 percent by mass of Mg, 0.1 to 1 percent by mass of Fe, 0.1 to 1 percent by mass of Mn, 0.15 to 0.3 percent by mass of Ti, 0.5 percent by mass or less of Ni, and a remaining portion containing Al and unavoidable impurities.

### BRIEF DESCRIPTION OF THE DRAWINGS

FIG. 1 is a view for explaining the structure of a jig with which relaxation resistance test is performed according to a first embodiment of the present invention;

FIG. 2 is a view for explaining a state in which bending stress is applied to a cast aluminum alloy in the relaxation resistance test of FIG. 1;

FIG. 3 is a view for explaining a state in which the bending stress is removed from the state of FIG. 2;

FIG. 4 is a view for explaining the structure of a device that performs the relaxation resistance test using the jig shown in FIG. 1;

FIG. 5 shows a micrograph at a magnification of 100× of a metal structure of Example 6;

FIG. 6 shows a micrograph at a magnification of 400× of the metal structure of Example 6;

FIG. 7 shows a micrograph at a magnification of 100× of a metal structure of Example 8;

FIG. 8 shows a micrograph at a magnification of 400× of the metal structure of Example 8;

FIG. 9 shows a micrograph at a magnification of 100× of a metal structure of Comparative Example 2;

FIG. 10 shows a micrograph at a magnification of 400× of the metal structure of Comparative Example 2;

FIG. 11 shows a micrograph at a magnification of 100× of a metal structure of Comparative Example 1;

FIG. 12 shows a micrograph at a magnification of 400× of the metal structure of Comparative Example 1;

FIG. 13 shows a micrograph at a magnification of 100× of a metal structure of Comparative Example 9;

FIG. 14 shows a micrograph at a magnification of 400× of a metal structure of Comparative Example 9;

FIG. 15 is a view for explaining the configuration of a compressor according to a second embodiment of the present invention; and

FIG. 16 is a view for explaining changes in axial force of bolt in the compressor shown in FIG. 15.

### DETAILED DESCRIPTION OF THE PREFERRED EMBODIMENTS

Cast aluminum alloys according to the present invention are preferably used as material of a compressor housing, or, more specifically, as material of housing members that form the compressor housing.

A cast aluminum alloy according to a first invention contains alloy elements and other elements by the following contents and for the following reasons.

Si: 9% By Mass to 17% By Mass

Si is essential to facilitate casting, suppress thermal expansion, and ensure relaxation resistance. If the Si content is less than 9% by mass, the content of eutectic Si becomes excessively small so that a network skeleton that suppresses occurrence of relaxation cannot be sufficiently formed. If the Si content exceeds 17% by mass, the liquidus-line temperature becomes significantly high. In this case, the casting temperature must be raised and problems such as gas absorption, oxidization, or wear of dies may be brought about. It is preferred that the aluminum alloy contains 9% by mass to 12% by mass of Si and has a hypoeutectic structure that does not contain primary crystal Si. The optimal range of the Si content is 10% by mass to 11% by mass. If the Si content exceeds 12% by mass, coarse primary crystals of Si are produced in the alloy. If such alloy is fatigued under high average tensile stress, the primary crystals of Si may be destroyed and fatigue strength may be lowered.

Cu: 3.5% By Mass to 6% By Mass

Cu effectively generates precipitate containing Cu and improves strength of the alloy. Particularly, at higher temperatures, Cu greatly increases the strength of the alloy. If the content of Cu is less than 3.5% by mass, the strength of the alloy is not improved sufficiently. If the Cu content exceeds 6% by mass, solidification-segregation occurs to a great extent and the obtained alloy becomes inhomogeneous. In this case, the ductility becomes significantly low and the fatigue strength under average tensile stress may be decreased. It is preferred that the Cu content be set to 4% by mass to 5% by mass.

Mg: 0.2% By Mass to 1.2% By Mass

Mg generates Mg₂Si precipitate, which precipitation-strengthens and enhances the strength of the alloy. Also, Mg generates a crystallized product of Mg₂Si, which dispersion-strengthens and thus further improves the strength of the alloy. If the Mg content exceeds 1.2% by mass, the amount of crystallization of Mg₂Si becomes excessively great, which lowers the ductility and thus the fatigue strength of the alloy. If the Mg content is less than or equal to 0.2% by mass, the amount of precipitation of Mg₂Si becomes low and thus the fatigue strength becomes insufficient. It is preferred that the Mg content be set to 0.6% by mass to 1% by mass.

Fe: 0.2% By Mass to 1.5% By Mass

Fe forms a crystallized product with high heat resistance. Homogeneous or network dispersion of such crystallized product and crystallized Si effectively suppresses occurrence of relaxation. If the Fe content is 0.2% by mass or less, the effect of such suppression of relaxation is limited to a low level. If the Fe content exceeds 1.5% by mass, a coarse crystallized product is formed. The crystallized product may provide a starting point of destruction and lower the fatigue strength under average tensile stress. Further, Fe improves seizure resistance of the alloy with respect to a casting mold. It is preferred that the Fe content be set to 0.3% by mass to 1% by mass.

Mn: 0 to 1% By Mass

Like Fe, Mn produces a crystallized product with high heat resistance and improves heat resistance of the base aluminum phase. This suppresses relaxation and improves the seizure resistance of the alloy with respect to the casting mold. Thus, although Mn is not an essential additive element, it is preferred that Mn be added to the alloy. If the Mn content is less than 0.2% by mass, the effect of suppression of relaxation is limited to a low level. If the Mn content exceeds 1% by mass, a coarse crystallized product is produced. The crystallized product may provide a starting point of destruction and lower the fatigue strength under the average tensile stress. It is preferred that the Mn content be set to 0.2% by mass to 0.7% by mass.

Ni: 0.5% By Mass or Less

Since Ni produces a coarse crystallized product and forms an inhomogeneous structure, Ni easily causes relaxation. Thus, the Ni content is set in a range greater than 0% by mass but not greater than 0.5% by mass. If the Cu content is high, particularly, a coarse crystallized product containing Cu and Ni is easily formed. Thus, it is not preferable to add Ni to the alloy. Also, added Ni significantly increases the density of the alloy. If the Ni content exceeds 0.5% by mass, a coarse crystallized portion is produced and relaxation occurs easily. Also, the density of the alloy becomes high and the weight of the final product increases.

The average hardness of the cast aluminum alloy according to the first invention is preferably HV130 to HV170 (Vickers hardness). In this case, the obtained cast aluminum alloy exhibits a further improved relaxation resistance compared to conventional cases.

The average hardness of the cast aluminum alloy having the above-described chemical composition according to the first invention is less than or equal to HV120 if the alloy is not subjected to heat treatment. However, such average hardness is adjusted to HV130 to HV170, or, more preferably, to HV130 to HV160, through a specific solution treatment and a specific aging treatment performed on the alloy. This improves the relaxation resistance of the alloy.

To determine the average hardness, Vickers hardness is measured at five or more points without a casting defect in a constant region of a cross section of the cast aluminum alloy maintained under the load of 10 kgf and for 30 sec. The average of the measurements is then determined as the average hardness of the alloy. If the cast aluminum alloy has a fine structure, measurements are varied among indented positions only to a small extent. In this case, regardless of whether the load is 5 kgf or 10 kgf, substantially equal measurements are obtained.

If such average hardness is less than HV130, the alloy has a decreased strength. Thus, intense and rapidly acting load may easily deform a component formed of the alloy. If the average hardness exceeds HV170, relaxation occurs easily. Accordingly, the average hardness is preferably HV140 to HV160, and, more preferably, to HV150 to HV160.

As has been described, if the hardness is set to a value slightly smaller than a maximum value obtained through peak aging treatment, the occurrence of relaxation is suppressed more effectively. Such discovery had been conventionally unknown and was discovered in the course of the present invention. Although some points of the mechanism involved in this discovery have yet to be made clear, it is assumed that the mechanism is brought about as follows.

The relaxation refers to the phenomenon in which, as an alloy is maintained at high temperature, stress acting in the alloy decreases. Since the alloy according to the present invention contains Cu and Mg, the precipitates of Cu and Mg, which have been formed through thermal treatment, are contained in the base aluminum phase. Such precipitates suppress slip deformation of the base aluminum phase and thus prevent relaxation. Also, it is considered that, as the precipitates become finer and are distributed with increased density in the alloy structure, the aforementioned slip deformation is suppressed more effectively. If the alloy is subjected to the peak aging treatment and the hardness of the alloy is increased, the corresponding precipitates become finer and are distributed with increased density. Thus, it has been conventionally considered that such alloy suppresses relaxation more effectively.

If the alloy is maintained at high temperature, a coarse precipitate is generated. In this state, if the alloy receives stress, it is considered that the stress is decreased as such precipitate is produced, which is referred to as stress aging. If averaging treatment is carried out on the alloy and the hardness of the alloy is decreased compared to the hardness obtained through the peak aging treatment, change of the precipitate becomes less pronounced in such alloy than that of the alloy that has been subjected to the peak aging treatment when these alloys are heated at equal temperatures. In other words, change of the structure of the precipitate of the alloy with the slightly decreased hardness is less pronounced. It is thus considered that such alloy prevents decrease of the stress and thus suppresses occurrence of relaxation.

After the cast aluminum alloy according to the first invention is cast, the alloy is subjected to the solution heating in which the alloy is maintained at 450° C. to 510° C. for 0.5 hour or longer. Afterwards, water quenching is performed on the alloy and then the alloy is subjected to the aging treatment in which the alloy is maintained at 170° C. to 230° C. for one to twenty-four hours. It is preferred that the hardness of the alloy be adjusted to the above-described average hardness in this manner.

If the treatment temperature of the solution heating is less than 450° C., an extremely long time is necessary for forming an oversaturated solid solution of Cu or Mg. In this case, optimal strength cannot be ensured through treatment of a short time, even if the treatment time falls in the aforementioned range. If the treatment temperature exceeds 510° C., burning, or melting of a portion of the alloy, is brought about, leading to an air hole defect. If the time of the treatment lasts less than 0.5 hour, the solution treatment cannot be sufficiently accomplished. It is thus preferred that the treatment last for an hour or longer. Solution of the alloy is obtained sufficiently under these conditions. However, the alloy does not change after the treatment time exceeds ten hours. This lowers production efficiency.

The coolant used for the water quenching may be normal water or coolant with a certain type of additive. That is, various types of publicly known quenching coolants may be employed.

If the temperature of the aging treatment is lower than 170° C., the treatment must be continued for a long time in order to improve the hardness of the alloy. If the temperature of the aging treatment exceeds 230° C., the hardness of the alloy decreases unnecessarily and the strength of the alloy significantly lowers. Thus, the treatment temperature is more preferably 190° C. to 210° C., and, most preferably, to 190° C. to 200° C. Further, if the treatment lasts for less than an hour, sufficient aging hardening cannot occur. If the treatment lasts exceeding twenty-four hours, the hardness of the alloy is excessively decreased or becomes saturated and lowers the production efficiency.

It is most preferred that, in a cast aluminum alloy according to a second invention, the proportion of dendrite in which five or more dendrite cells be aligned substantially along one direction is not more than 20% by the surface area rate and that the cast aluminum alloy has an isotropic homogeneous structure substantially without alignment of the dendrite. This further improves the relaxation resistance of the alloy.

Specifically, through control of the elements and the form of the structure of the alloy, a tough dispersion-strengthened structure that suppresses deformation at high temperature is formed. Also, heat resistant improving elements in the base Al phase suppress such deformation at high temperature. It is considered that these factors improve the relaxation resistance of the alloy. Further, it is considered that, since the crystallized products are isotropically dispersed and strengthened, stress distribution becomes uniform and the fatigue strength of the alloy is improved.

Also, the alloy according to the present invention contains little Ni, which is expensive, the cost for the material is saved. Such scarce content of Ni suppresses generation of a coarse crystallized product. Thus, through isotropic dispersion of fine crystallized products with uniform sizes, the fatigue strength and the relaxation resistance of the alloy are improved by the crystallized products without wasting the crystallized products. Such effect becomes pronounced at the high temperature not more than 200° C.

In the isotropic homogeneous structure, a eutectic area is formed in a network manner or crystallized products are dispersed homogeneously. Such structure is accomplished if the alloy is substantially without alignment of dendrite. In the present invention, “the alloy being substantially without alignment of dendrite” refers to that the surface area of a dendrite structure (hereinafter, referred to as an aligned dendrite structure) in which five or more dendrite cells are aligned substantially along one direction is 20% or less of the total surface area of the structure.

The surface area rate of the aligned dendrite structure is more preferably 10% or less and, most preferably, 5% or less.

To obtain such isotropic homogeneous structure, the following specific composition of the elements is an essential condition. The contents of the elements of the cast aluminum alloy according to the second invention are limited to the following ranges for the following reasons.

Si: 9% By Mass to 17% By Mass

Si is essential to form a network skeleton of eutectic Si. If the Si content is less than 9.5% by mass, the content of eutectic Si becomes excessively small so that the network skeleton that suppresses occurrence of relaxation cannot be sufficiently formed. If the Si content exceeds 17% by mass, the liquidus-line temperature becomes significantly high. In this case, the casting temperature must be raised and problems such as gas absorption, oxidization, or wear of dies may occur. It is preferred that the aluminum alloy contain 9% by mass to 12% by mass of Si. The optimal range of the Si content is 10% by mass to 11% by mass. If the Si content exceeds 12% by mass, coarse primary crystal Si is produced in the alloy. If such alloy is fatigued under high average tensile stress, the coarse primary crystal Si may be destroyed and the fatigue strength of the alloy may be lowered.

Cu: 3.5% By Mass to 6% By Mass

Cu effectively generates precipitate containing Cu and improves the strength of the alloy. Particularly, at high temperature, Cu effectively increases the strength of the alloy. If the content of Cu in the alloy is less than 3.5% by mass, the strength of the alloy is not improved sufficiently. If the Cu content exceeds 6% by mass, solidification-segregation occurs to a great extent and the obtained alloy becomes inhomogeneous. In this case, the ductility becomes significantly low and the fatigue strength under average tensile stress may be decreased. It is preferred that the Cu content be set to 4% by mass to 5% by mass.

Mg: 0.3% By Mass to 1.2% By Mass

Mg generates Mg₂Si precipitate, which precipitation-strengthens and increases the strength of the alloy. Also, Mg generates a crystallized product of Mg₂Si, which dispersion-strengthens and thus further improves the strength of the alloy. If the Mg content exceeds 1.2% by mass, the amount of crystallization of Mg₂Si becomes excessively great, which disadvantageously lowers the ductility and thus the fatigue strength of the alloy. If the Mg content is less than or equal to 0.3% by mass, the amount of precipitation of Mg₂Si becomes low and thus the fatigue strength becomes insufficient. The Mg content is set to preferably 0.4% by mass to 1% by mass and, more preferably, 0.6% by mass to 1% by mass.

Fe: 0.1% By Mass to 1% By Mass

Fe forms a crystallized product with high heat resistance and strengthens a network skeleton formed of the crystallized product. This effectively improves the relaxation resistance of the alloy. If the Fe content is less than 0.1% by mass, the effect of suppression of relaxation is limited to a low level. If the Fe content exceeds 1% by mass, a coarse crystallized product is formed. Such crystallized product may provide a starting point of destruction and lower the fatigue strength under average tensile stress. Further, Fe improves seizure resistance of the alloy with respect to a casting mold. It is preferred that the Fe content be set to 0.3% by mass to 1% by mass.

Mn: 0.1 to 1% By Mass

When added to the alloy, Mn produces a crystallized product with high heat resistance and strengthens a network skeleton formed by the crystallized product. Mn thus improves the relaxation resistance. Also, Mn improves the seizure resistance of the alloy with respect to a casting mold. If the Mn content is less than 0.1% by mass, the effect of suppression of relaxation is limited to a low level. If the Mn content exceeds 1% by mass, a coarse crystallized product is produced. Such crystallized product may provide a starting point of destruction and lower the fatigue strength under the average tensile stress. It is preferred that the Mn content be set to 0.2% by mass to 1% by mass.

Ti: 0.15% By Mass to 0.3% By Mass

Ti fines the crystal particles of the α-Al phase, suppresses alignment of dendrite cells, and homogenizes a solidified structure. Also, Ti increases heat resistance of the base aluminum phase and improves the relaxation resistance of the base aluminum phase.

If the Ti content is less than 0.15% by mass, the solidified structure is homogenized. If the alloy is a hypoeutectic structure, a network skeleton structure formed by a crystallized product cannot be provided isotropically. If the alloy is a hypereutectic structure, an isotropic homogenous dispersion structure of a crystallized product cannot be formed. Also, the Ti content in the base aluminum phase becomes low and the relaxation resistance of the base aluminum phase becomes insufficient.

If the Ti content exceeds 0.3% by mass, a coarse Ti compound is formed. This decreases the ductility. Also, such compound may provide a starting point of fatigue destruction and decrease the fatigue strength of the alloy under average tensile stress.

If Ti is added to the alloy in the forms of Al—Ti—B alloy or Al—Ti—C alloy, content of B or C may be permitted. The range of the Ti content is preferably 0.15% by mass to 0.25% by mass. If the Ti content is 0.15% by mass or greater, the crystal particles are fined sufficiently. This increases homogeneity of the structure and isotropy of the network skeleton structure, thus further improving the relaxation resistance of the alloy. Also, variation of the fatigue strength is suppressed and the lower limit of the fatigue strength is improved. The Ti content is further optimally 0.2% to 0.25% by mass. If the Ti content falls in this range, the relaxation resistance of the alloy is maximally improved.

Ni: 0.5% By Mass or Less

Since Ni produces a coarse crystallized product and causes an inhomogeneous structure, Ni easily causes relaxation. Thus, the Ni content is set in a range greater than 0% by mass but not greater than 0.5% by mass. If the Cu content is high, particularly, a coarse crystallized product containing Cu and Ni is easily formed. It is thus not preferable to add Ni to the alloy. Also, added Ni significantly increases the density of the alloy. If the Ni content exceeds 0.5% by mass, a coarse crystallized portion is formed and relaxation occurs easily. Also, the density of the alloy becomes high and the weight of the final product increases.

Further, it is preferred that the cast aluminum alloy according to the second invention also contain 0.05% by mass to 0.15% by mass of Zr and 0.02% by mass to 0.15% by mass of V.

Zr: 0.05% By Mass to 0.15% By Mass

Like Ti, Zr fines the crystal particles in the α-Al phase, suppresses alignment of dendrite, and homogenizes the solidified structure. Zr also increases the heat resistance of the base aluminum phase and improves the relaxation resistance of the base aluminum phase. To sufficiently homogenize the solidified structure and ensure heat resistance, 0.05% by mass or more of Zr may be preferably contained in the alloy. If the Zr content is less than 0.05% by mass, fining of the crystal particles may not reach a level sufficient for homogenizing the solidified structure. Further, in this case, the Zr content in the base aluminum phase becomes low, resulting in insufficient heat resistance. If the Zr content exceeds 0.3% by mass, a coarse Zr compound is formed and may provide a starting point of fatigue. If Zr is used in combination with Ti, the effect of improvement of the relaxation resistance is further improved.

V: 0.02% By Mass to 0.15% By Mass

V is contained mainly in the base aluminum phase and enhances the heat resistance, thus improving the relaxation resistance. Such effect becomes pronounced when 0.02% by mass or more of V is contained in the alloy. If the V content in the alloy exceeds 0.15% by mass, the melting point of the alloy rises and problems such as gas absorption may occur. Also, in this case, a coarse V compound is formed and may provide a starting point of fatigue destruction. It is preferred that the V content be set to 0.02% by mass to 0.12% by mass. If V is used in combination with Ti, the heat resistance of the base aluminum phase is maximally enhanced. Such combined use is thus optimal. If the alloy contains Ti, Zr, and V, the effects of the respective elements synergize so that the most improved relaxation resistance is obtained.

It is also preferred that the cast aluminum alloy according to the second invention contain 9% by mass to 12% by mass of Si and 0.001% by mass or less of P and have a hypoeutectic structure that does not contain primary crystal Si. In other words, it is preferred that, if the alloy is a hypoeutectic structure, the P content be limited to 0.001% by mass or less.

If the P content in the alloy increases, the eutectic point of the alloy becomes offset. In this case, coarse primary crystal Si may be produced regardless of that the elements of the alloy fall in the ranges of the present invention. Such primary crystal Si may provide a starting point of fatigue destruction and lower the fatigue strength under the average tensile stress. The P content thus may be preferably set to 0.001% by mass or less, or, ideally, to 0.

Contrastingly, if the alloy is a hypereutectic structure, it is preferred that the P content in the alloy be 0.005% by mass to 0.015% by mass. With P contained in the alloy, fine primary crystal Si is formed and the fatigue strength under the average tensile stress improves. If the P content is less than 0.005% by mass, the primary crystal Si does not become sufficiently fine. If the P content in the alloy exceeds 0.015% by mass, fining of the primary crystal Si becomes saturated. This decreases flowability of the molten metal.

Also, it is preferred that the cast aluminum alloy according to the second invention contain at least one of 0.0005% by mass to 0.01% by mass of Ca, 0.0005% by mass to 0.003% by mass of Na, 0.003% by mass to 0.03% by mass of Sr, and 0.05% by mass to 0.2% by mass of Sb.

Ca: 0.0005% By Mass to 0.01% By Mass

Ca fines eutectic Si, produces a wide network skeleton formed of fine Si, and suppresses relaxation. If the Ca content is less than 0.0005% by mass, the eutectic Si does not become sufficiently fine. If the Ca content exceeds 0.01% by mass, the molten metal easily oxidizes. In this case, oxide may be contained in the cast metal or gas absorption may increase and form a number of air hole defects in the alloy.

Na: 0.0005% By Mass to 0.003% By mass

Na fines eutectic Si and thus provides an advantage equivalent to that of Ca. If the Na content is less than 0.0005% by mass, the eutectic Si does not become sufficiently fine. If the Na content exceeds 0.003% by mass, absorbed gas may increase and form a number of air hole defects in the alloy.

Sr: 0.003% By Mass to 0.03% By Mass

Sr fines eutectic Si and thus provides an advantage equivalent to that of Ca. If the Sr content is less than 0.003% by mass, the eutectic Si does not become sufficiently fine. If the Sr content exceeds 0.03% by mass, absorbed gas may increase and form a number of air hole defects in the alloy.

Sb: 0.05% By Mass to 0.2% By Mass

Sb fines eutectic Si and thus provides an advantage equivalent to that of Ca. If the Sb content is less than 0.05% by mass, the eutectic Si does not become sufficiently fine. If the Sb content exceeds 0.2% by mass, absorbed gas may increase and form a number of air hole defects in the alloy.

Na easily reacts with mold wash on a furnace wall and damages the furnace wall. Sr easily absorbs gas and the effect of fining of the eutectic Si by Sb is limited to a relatively low level. Accordingly, it is most preferable to add Ca to the alloy.

Also, in the second invention, it is preferred that the composition of the elements of the cast aluminum alloy be adjusted in such a manner that the density of the alloy becomes 2.8 g/cm³ or less. In this manner, the aluminum alloy forming a housing of a compressor further effectively decreases the weight of the compressor.

It is also preferred that the average hardness of the cast aluminum alloy of the second invention be HV130 to HV170, as in the first invention.

After having been cast, the cast aluminum alloy is subjected to solution heating in which the alloy is maintained at 450° C. to 510° C. for 0.5 hour or longer. Then, water quenching is performed on the alloy and followed by aging treatment in which the alloy is maintained at 170° C. to 230° C. for one to twenty-four hours. It is preferred that the aforementioned average hardness is adjusted in this manner.

Through these steps, the aforementioned isotropic homogeneous structure is provided and the relaxation resistance is further effectively improved.

Further, it is preferred that the average major axis of the crystallized Si in the cast aluminum alloy according to the second invention be 5 μm or less. The crystallized Si is mainly eutectic Si and becomes more preferable as the particle size of the crystallized Si is smaller. If the average major axis of the crystallized Si exceeds 5 μm, slip deformation occurs in the interface between the crystallized product and the base aluminum phase, hampering suppression of relaxation. Thus, the average major axis of the crystallized Si is preferably 4 μm or less and, more preferably, 3 μm or less.

It is also preferred that the cast aluminum alloy of each of the first and second inventions further contain at least one of 0.01% by mass to 0.1% by mass of Sn, 0.02% by mass to 0.15% by mass of Pb, and 0.1% by mass to 1% by mass of Zn.

Sn: 0.01% By Mass to 0.1% By Mass

If Sn is contained in the alloy, recycled mass can be used as material and recycling efficiency is increased. If the Sn content is less than 0.01% by mass, the alloy cannot be used as recycled alloy and the selection range of materials is limited. If the Sn content exceeds 0.1% by mass, the heat resistance is decreased and relaxation easily occurs in the alloy.

Pb: 0.02% By Mass to 0.15% By Mass

Like Sn, Pb improves recycling efficiency. If the Pb content is less than 0.02% by mass, the selection range of materials is limited. If the Pb content exceeds 0.15% by mass, the heat resistance is decreased and relaxation easily occurs in the alloy.

Zn: 0.1% By Mass to 1% By Mass

Like Sn and Pb, Zn improves recycling efficiency. If the Zn content is less than 0.1% by mass, the selection range of materials is limited. If the Zn content exceeds 1% by mass, the heat resistance is decreased and relaxation easily occurs in the alloy.

It is also preferred that the Si content in the base Al phase of the cast aluminum alloy be 0.95% by mass or greater. This suppresses slip deformation of the base aluminum phase and prevents relaxation from occurring in the alloy.

It is further preferred that the housing members be fastened together using bolts formed of steel. This firmly fastens the housing members together.

It is further preferred that the housing include a sealing structure that generates surface pressure in contact portions of the housing members using axial force produced by the bolts and thus prevents the refrigerant from leaking from the interior of the housing. This improves the relaxation resistance of, particularly, the housing members and provides a compressor with enhanced sealing performance.

It is also preferred that the refrigerant be carbon dioxide. To compress the carbon dioxide, increased compressive pressure is needed compared to the compressive pressure necessary for conventional refrigerant. Correspondingly, the housing of the compressor must have improved sealing performance. It is thus effective to form the housing members using the cast aluminum alloy exhibiting the improved relaxation resistance.

The concept of the present invention will hereafter be explained briefly.

Since relaxation and creep are inextricably connected, it has been considered that material with an improved creep resistance improves relaxation resistance. That is, it is generally assumed that material with improved tolerance or strength is superior in the relaxation resistance. However, in the present invention, it has been discovered, for the first time, that, as long as cast aluminum alloy used to form a compressor is concerned, a material with enhanced strength or tolerance does not necessarily exhibit improved relaxation resistance. Specifically, it has been demonstrated that the material that has been subjected to the averaging treatment and has slightly lowered strength and slightly decreased hardness prevents relaxation more effectively than the conventional material that has been subjected to T6 heat treatment (JIS: Japan Industrial Standards) and has peak strength and peak hardness.

Heat-resistant magnesium alloy easily relaxes, which causes a major problem in actual use. In the study of the heat-resistant magnesium alloy, it is known that a network skeleton formed by heat-resistant particles that are continuously connected together stops deformation in the particles and thus suppresses relaxation. However, in the present invention, it has been discovered, for the first time, that the skeleton does not necessarily have to be continuous and that relaxation is further effectively suppressed by a wide network skeleton area formed by an aggregate of fine particles.

Further, the network is formed isotropically and the base aluminum phase, around which the network is arranged, contains heat-resistant elements to suppress slip deformation. In other words, the structure as a whole is designed optimally to prevent relaxation through multi-scale structure control, which is provided through combining micro-structure control and macro-structure control. Accordingly, the cast aluminum alloy having an unprecedented improved relaxation resistance has been provided for the first time.

It has been discovered, for the first time, that such optimal designing detoxifies Sn, Pb, and Zn, or the harmful elements that easily cause relaxation in metal with a low melting point, contained in the alloy and thus maintains the improved relaxation resistance. Such detoxification significantly improves recycling efficiency of the alloy and provides alloy with extremely low environmental load and extremely great practical value. Accordingly, the alloy according to the present invention is extremely valuable for industrial use.

A first embodiment of the cast aluminum alloy used for a compressor according to the present invention will now be explained.

In the first embodiment, the different types of cast aluminum alloys (Examples 1 to 9 and Comparative Examples 1 to 10), which are represented by Tables 1, 2, and 3, were prepared and the resistance of these alloys were evaluated.

The alloys in Table 1 are examples of the above-described first invention and the alloys in Table 2 are examples of the above-described second invention. The alloys in Table 3 are examples of the second invention that have an increased number of essential elements to allow use of recycled metal.

First, aluminum alloys having the chemical compositions represented in Tables 1 to 3 were prepared. Specifically, molten metals with adjusted elements were prepared and flux was provided to the molten metals at the temperatures of 740° C. to 760° C., subjecting the metals to deacidification treatment. Then, degassing treatment with hexachloroethane and Ar gas bubbling were performed on the molten metals and the molten metals were cast, at 730° C., into a JIS4 test-sample-taking boat-shaped die or a Ransley copper die that had been pre-heated to 200° C. Subsequently, solution heating was performed on the obtained cast materials at 500° C. for three hours and then water quenching was carried out on the materials. Afterwards, the cast materials were subjected to aging treatment under the conditions represented in the respective Tables.

TABLE 1

| | | | | | | | | | | | | | | | | Aging |
|---|---|---|---|---|---|---|---|---|---|---|---|---|---|---|---|---|
| | | | | | | | | | | | | | | | | Conditions |
| | Chemical Composition (% by mass) | | | | | | | | | | | | | | | (Temperature |
| Samples | Si | Cu | Mg | Fe | Mn | Ni | Ti | Zr | V | P | Ca | Na | Pb | Sn | Zn | & Time) |
| Comparative | 10.2 | 2.01 | 0.18 | 0.79 | 0.25 | 0.04 | | | | | | | 0.06 | 0.02 | 0.62 | 200° C. 5 h |
| Example 1 | | | | | | | | | | | | | | | | |
| Comparative | 10.5 | 4.59 | 0.79 | 0.55 | 0.26 | 0.00 | 0.01 | | | | 0.002 | | | | 0.01 | 180° C. 8 h |
| Example 2 | | | | | | | | | | | | | | | | |
| Comparative | 12.8 | 3.11 | 0.71 | 0.44 | 0.41 | 2.08 | 0.22 | 0.1 | 0.05 | 0.011 | | | | | 0.01 | 210° C. 3 h |
| Example 3 | | | | | | | | | | | | | | | | |
| Comparative | 11.0 | 3.20 | 0.70 | 0.40 | 0.40 | 2.00 | 0.20 | 0.1 | 0.05 | | | | | | 0.01 | 210° C. 3 h |
| Example 4 | | | | | | | | | | | | | | | | |
| Comparative | 11.0 | 3.20 | 0.70 | 0.40 | 0.40 | 2.00 | 0.20 | 0.1 | 0.05 | | | | | | 0.01 | 180° C. 5 h |
| Example 5 | | | | | | | | | | | | | | | | |
| Comparative | 11.0 | 3.20 | 1.50 | 0.40 | 0.40 | 2.00 | 0.20 | 0.1 | 0.05 | | | | | | 0.01 | 180° C. 5 h |
| Example 6 | | | | | | | | | | | | | | | | |
| Comparative | 10.2 | 2.01 | 0.18 | 0.79 | 0.25 | 0.04 | | | | | | | 0.06 | 0.02 | 0.62 | 180° C. 5 h |
| Example 7 | | | | | | | | | | | | | | | | |
| Comparative | 11.0 | 6.50 | 0.70 | 0.40 | 0.40 | 0.00 | 0.01 | | | | | | | | 0.01 | 180° C. 5 h |
| Example 8 | | | | | | | | | | | | | | | | |
| Example 1 | 10.5 | 4.59 | 0.79 | 0.55 | 0.26 | 0.00 | 0.01 | | | | | | | | 0.01 | 200° C. 5 h |
| Example 2 | 11.0 | 3.80 | 0.80 | 0.40 | 0.40 | 0.00 | 0.01 | | | | | | | | 0.01 | 200° C. 5 h |
| Example 3 | 11.0 | 5.30 | 0.70 | 0.40 | 0.40 | 0.00 | 0.01 | | | | | | | | 0.01 | 200° C. 5 h |

TABLE 2

| | | | | | | | | | | | | | | | | Aging |
|---|---|---|---|---|---|---|---|---|---|---|---|---|---|---|---|---|
| | | | | | | | | | | | | | | | | Conditions |
| | Chemical Composition (% by mass) | | | | | | | | | | | | | | | (Temperature |
| Samples | Si | Cu | Mg | Fe | Mn | Ni | Ti | Zr | V | P | Ca | Na | Pb | Sn | Zn | & Time) |
| Example 4 | 10.5 | 4.60 | 0.80 | 0.55 | 0.26 | <0.01 | 0.22 | 0.1 | 0.05 | | 0.001 | | | | | 200° C. 5 h |
| Example 5 | 10.5 | 4.60 | 0.80 | 0.55 | 0.26 | <0.01 | 0.22 | 0.1 | 0.05 | | 0.001 | | | | | 220° C. 6 h |
| Example 6 | 10.5 | 4.60 | 0.80 | 0.55 | 0.26 | <0.01 | 0.22 | 0.1 | 0.05 | | 0.003 | | | | | 200° C. 5 h |
| Example 7 | 10.5 | 4.60 | 0.80 | 0.55 | 0.26 | <0.01 | 0.22 | 0.1 | 0.05 | | | 0.001 | | | | 200° C. 5 h |
| Example 8 | 10.5 | 4.60 | 0.80 | 0.40 | 0.40 | <0.01 | 0.20 | 0.1 | 0.05 | | 0.003 | | | | | 200° C. 5 h |
| Comparative | 12.5 | 4.60 | 0.80 | 0.55 | 0.40 | 3.00 | 0.22 | 0.1 | 0.05 | 0.010 | | | | | | 200° C. 5 h |
| Example 9 | | | | | | | | | | | | | | | | |

TABLE 3

| | | | | | | | | | | | | | | | | Aging |
|---|---|---|---|---|---|---|---|---|---|---|---|---|---|---|---|---|
| | | | | | | | | | | | | | | | | Conditions |
| | Chemical Composition (% by mass) | | | | | | | | | | | | | | | (Temperature |
| Samples | Si | Cu | Mg | Fe | Mn | Ni | Ti | Zr | V | P | Ca | Na | Pb | Sn | Zn | & Time) |
| Example 9 | 10.5 | 4.50 | 0.80 | 0.73 | 0.23 | 0.04 | 0.20 | 0.1 | 0.05 | | 0.003 | | 0.05 | 0.02 | 0.57 | 200° C. 5 h |
| Comparative | 10.5 | 4.60 | 0.80 | 0.72 | 0.23 | 0.04 | 0.20 | 0.1 | 0.05 | | 0.003 | | 0.30 | 0.20 | 0.56 | 200° C. 5 h |
| Example 10 | | | | | | | | | | | | | | | | |

Test samples for a fatigue test, observation of the structures and evaluation of the relaxation resistance were taken from the cast materials that had been subjected to the heat treatment in the above-described manner.

Details of these test samples and the methods of testing are as follows.

Relaxation Resistance Evaluation Test

Each of the test samples for the relaxation resistance evaluation test was sized to have a width of 10 mm, a thickness of 1.3 mm, and a length of 55 mm. Each test sample was taken from the corresponding one of the materials maintained in a state in which the width direction of the test sample extended in an up-and-down direction of the boat-shaped material from the bottom surface of the boat-shaped die.

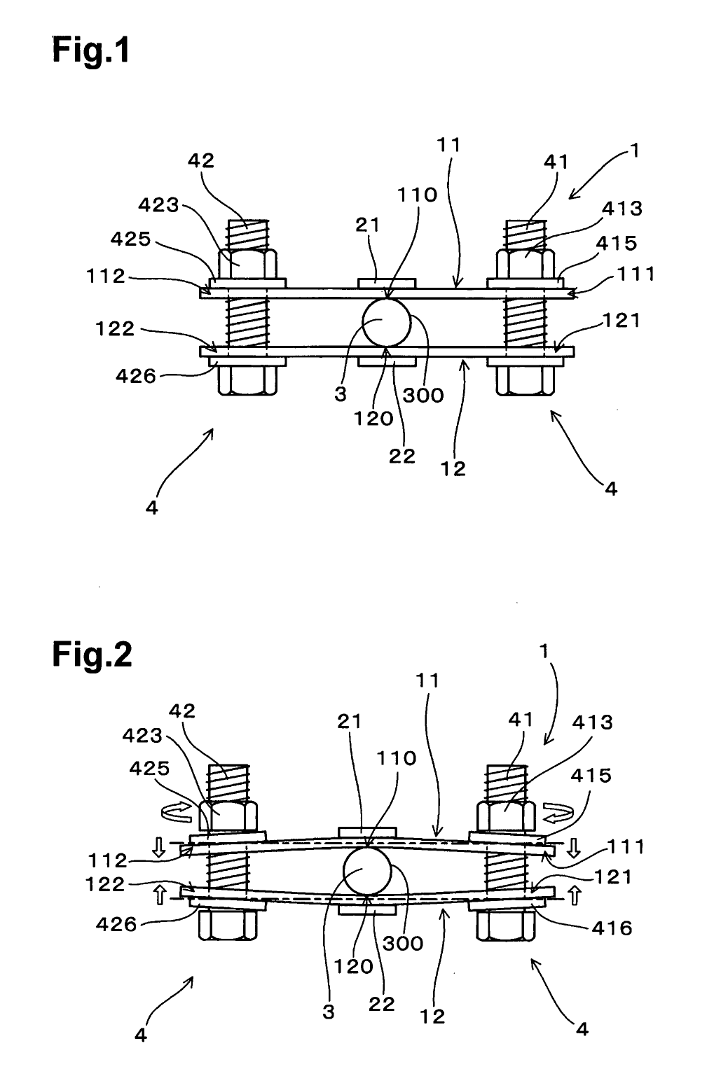

As illustrated in FIGS. 1 to 4, the relaxation resistance of the materials was evaluated using a relaxation test jig 1, which will be described in the following.

As shown in FIG. 1, the relaxation test jig 1 has a pair of test samples 11, 12, a support member 3 clamped between the test samples 11, 12, holding members 4, and high-temperature strain gauges 21, 22 serving as displacement detecting portions. One of the holding members 4 holds an end 111 of the test sample 11 and an end 121 of the test sample 12. The other holding member 4 holds an end 112 of the test sample 11 and an end 122 of the test sample 12. Each of the strain gauges 21, 22 detects strain displacement of the corresponding one of the test samples 11, 12.

Referring to FIG. 1, a circular rod-like support member 3 is formed of SUS304 (JIS) with improved heat resistance and has an arcuate outer circumferential surface 300. The diameter of the support member 3 is 6 mm and the length of the support member 3 is 25 mm.

One of the holding members 4 includes a bolt 41 and a nut 413 engaged with the bolt 41. The other holding member 4 includes a bolt 42 and a nut 423 engaged with the bolt 42. Each of the holding members 4 stabilizes the fastening of and prevents loosening of the corresponding one of the nuts 413, 423 using washers 415, 416 or washers 425, 426. All of the components of each holding member 4 are formed of SUS304 with improved heat resistance, which is the same material as the material of the support member 3.

In the first embodiment, as illustrated in FIGS. 1 to 3, the test samples 11, 12 are opposed to each other with the gauges 21, 22 facing to the exterior. The support member 3 is clamped between a central portion 110 of the test sample 11 and a central portion 120 of the test sample 12. The holding members 4 hold the test samples 11, 12 and apply a predetermined level of bending stress to the test samples 11, 12. Further, each holding member 4 maintains the strain displacement of each of the test samples 11, 12 using such bending stress.

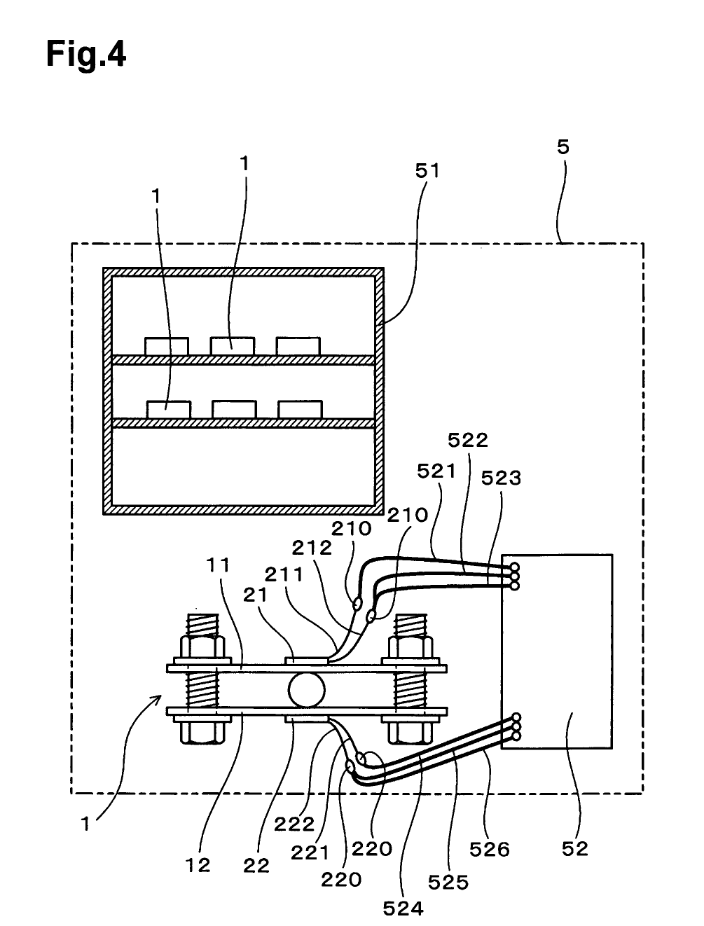

As shown in FIG. 4, a relaxation test device 7 includes the relaxation test jig 1, a heating chamber 71, and a multi-channel type static strain gauge 52 serving as a strain measurement device. The test samples 11, 12 are heated in the heating chamber 71. The static strain gauge 52 is connected to the gauges 21, 22 and measures the strain displacement of the test samples 11, 12. As the heating chamber 71, a warm-air circulation type constant temperature oven (set temperature: 50° C. to 300° C., temperature distribution: ±5° C.) was employed.

Further, with reference to FIG. 4, gauge leads 211, 212 (221, 222) are connected to the high-temperature strain gauge 21 (22). Leads 521, 522, 523 (524, 525, 526) with a low level of electric resistance are connected to the static strain gauge 52. The gauge leads 211, 212 (221, 222) and the leads 521 to 523 (524 to 526) are connected together at a connecting portion 210 (220) through soldering.

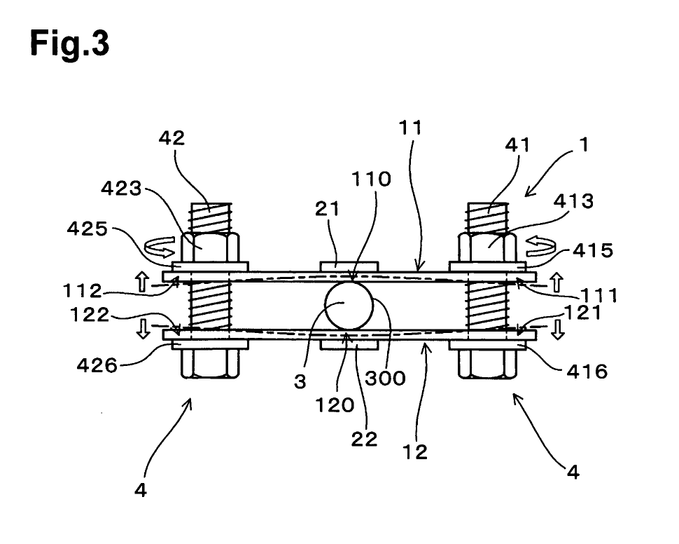

The relaxation test included a heating step and a step of determining remaining stress. In the heating step, the test samples 11, 12 were heated for a predetermined time while the strain displacement caused by the bending stress in the test samples 11, 12 was maintained constant, as illustrated in FIG. 2. In the step of determining the remaining stress, after the test samples 11, 12 had been cooled, the bending stress acting on the test samples 11, 12 were removed, as illustrated in FIG. 3. Then, the strain displacement caused in each test sample 11, 12 was detected by the corresponding high-temperature strain gauge 21, 11 to obtain the remaining stress. In the first embodiment, the test samples 11, 12 were maintained under the conditions of the initial load stress of 200 MPa, the test temperature (the heating temperature) of 180° C., and the test time of 300 h. Afterwards, the stress or remaining in each of the test samples 11, 12 was determined.

Observation of Structure

The samples for observing the structures of the materials were taken from the boat-shaped cast material at the position corresponding to the height of 14 mm from the bottom of the boat-shaped die, as in the case of the fatigue test samples. In the observation of the structure, the surface area rate Adp(%) of the dendrite structure (the aligned dendrite structure) in which five or more dendrite cells are aligned substantially in one direction was determined. Specifically, a micrograph of the structure with the field of view of approximately 1.4 mm×1 mm was taken using an optical microscope at a magnification of 100×. Then, the entire portion of the dendrite structure in which the five or more dendrite cells were aligned substantially in one direction was filled in. Subsequently, the surface area rate of the filled in portion was obtained using image processing software.

The average major axis DsL (μm) was obtained as the average of the major axes of all of the observed particles. The major axis of each of the particles was the length of the longest line that passes the center of gravity of the particle and connects two points on the outer circumference of the particle.

Hardness Test

Each of the test samples of the hardness test was taken from the corresponding one of the boat-shaped materials at the position corresponding to the height of approximately 14 mm from the bottom of the boat-shaped die. The surface of each test sample was subjected to mirror finishing. Subsequently, a portion without casting defects was indented under the conditions of the load of 10 kgf and the load time of 30 sec. Normal measurements were then obtained from five or more points, excluding abnormal measurements influenced by casting defects, and the average of the normal measurements was calculated. In this manner, the Vickers hardness HV as the average hardness was determined.

The results of each of the tests are shown in Tables 4 to 6.

Table 4 shows the results with the examples related to the first invention, which are represented in Table 1.

As represented in Tables 1 and 4, the alloy of Example 1 had a high Cu content and tends to exhibit high rigidity. However, through aging treatment at 200° C. for 5 h (in which the alloy was maintained at 200° C. for five hours), the average hardness HV was adjusted to 160 or less. After the relaxation resistance evaluation test in which the alloy was maintained at 180° C. for 300 hours, the stress (the remaining stress σr) remaining in Example 1 remained high.

Each of the alloys of Examples 2, 3 had a Cu content close to the upper limit or the lower limit of the present invention. However, the hardness of each alloy fell in the range of the first invention and exhibited high remaining stress σr.

As in Examples 1 and 3, the alloy of Comparative Example 2 had a high Cu content. Further, the average hardness HV exceeded 160 through heat treatment at 180° C. for 8 h. The alloy of Comparative 2 thus had low remaining stress σr.

The Cu content and the Mg content of the alloy of Comparative Example 1 were excessively low. Thus, the average hardness of this alloy was less than 130 and the remaining stress σr was low.

The alloys of Comparative Examples 3 to 5 each had a low Cu content and contained Ni. Thus, these alloys had low remaining stress σr.

The alloy of Comparative Example 6 had a low content of Cu and a high content of Mg. Thus, the remaining stress σr of this alloy was low.

The average hardness HV of each of the alloys of Comparative Examples 2, 5, 6 exceeded 160. The remaining stress σr of each of these alloys was thus low.

The Cu content of the alloy of Comparative Example 8 exceeded 6% and the average hardness HV of this alloy exceeded 160. Thus, the remaining stress σr of this alloy was low and the density of the alloy was higher than 2.8 g/cm³.

As is clear from these results, the cast aluminum alloy according to the first invention, which contains 3.5% by mass to 5% by mass of Cu and 0.5 % by mass or less of Ni and has hardness adjusted to HV130 to HV160 through the heat treatment, exhibits an improved relaxation resistance.

Table 5 shows the results from the examples related to the second invention represented in Table 2.

As represented in Tables 2 and 5, the alloys of Examples 4 to 8 are the alloys of the second invention. That is, each of these alloys contained an appropriate amount of Ti, an appropriate amount of Zr, and an appropriate amount of V and had a homogeneous structure in which the surface area of the aligned dendrite structure is 20% or less. Also, the hardness of each of the alloys of Examples 4 to 8 was adjusted to an appropriate level through the heat treatment. As a result, compared to the alloy of Example 1 that contained neither Zr nor V, the alloys of Examples 4 to 8 each exhibited further improved relaxation resistance.

Comparative Example 9 had a greater content of Si compared to the ranges of the elements of the alloy according to the second invention. The alloy of Comparative Example 9 also contained Ni and P and had greater average hardness. As a result, the remaining stress σr of Comparative Example 9 was lower than those of Examples 1 to 8.

The density of the alloy of Comparative Example 9 was 2.8 g/cm³ or greater, which was higher than those of the alloys of Examples 1 to 8. This increased the weight of the cast metal.

The alloy of Example 6 is optimal as the alloy according to the second invention. That is, the surface area rate of the aligned dendrite structure is low, or 5% or less, and has an extremely isotropic network structure. Also, the alloy of Example 6 has small crystallized Si with the average major axis of 3 μm or less and has a structure in which an aggregate of fine eutectic Si forms a wide network skeleton. As a result, the alloy of Example 6 exhibits further improved relaxation resistance compared to the alloys of Examples 4, 5, 7, and 8.

The average major axis of each of the alloys of Examples 4, 5, and 7 is greater than that of the optimal alloy of Example 6, or 5 μm or greater. The surface area rate of the aligned dendrite structure of the alloy of Example 8 is slightly greater than that of the optimal alloy of Example 6, or 10% or greater. Accordingly, as has been described, although the relaxation resistance of each of the alloys of Examples 4, 5, 7, and 8 are slightly inferior to those of the optimal alloy of Example 6, the relaxation resistance of each of the alloys of Examples 4, 5, 7, and 8 are sufficiently improved compared to the conventional alloys of Comparative Examples 1 to 9.

Table 6 shows the results from the examples related to the second invention, each of which contains a further increased number of essential elements than the alloys of Table 2 and allows use of recycled metal, as is represented in Table 3.

With reference to Tables 3 and 6, the alloy of Example 9 was formed containing the recycled metal and contains an appropriate amount of Pb, an appropriate amount of Sn, and an appropriate amount of Zn. Since the contents of these elements were appropriate levels, the remaining stress σr of the alloy of Example 9 was higher than those of the alloys of Comparative Examples 1 to 9. Further, since the alloy of Example 9 contained Sn, Pb, and Zn, the recycled metal can be used as the material of this metal, as has been described, and recycling efficiency of the metal is enhanced. Use of such alloy significantly decreases the energy needed for forming the alloy and extremely improves the effect of reduction of CO₂.

The alloy of Comparative Example 10 was formed using the recycled metal containing Sn, Pb, and Zn, as in the case of the alloy of Example 9. However, the contents of Sn, Pb, and Zn were inappropriate. This significantly lowered the remaining stress σr of this alloy compared to that of the alloy of Example 9. That is, as long as the contents of Sn, Pb, and Zn are adjusted appropriately in the alloy according to the second invention, an alloy having improved recycling efficiency and enhanced relaxation resistance is provided.

TABLE 4

| | | Aligned | | | | Relaxation |
|---|---|---|---|---|---|---|
| | | Dendrite | Major Axis of | | | Resistance |
| | Average | Surface Area | Crystallized | | Use of | (Remaining |
| | Hardness | Rate | Si | Density ρ | Recycled | Stress) |
| Samples | HV | Adp | DsL (μm) | (g/cm³) | Mass | σr (Mpa) |
| Comparative | 111 | 65% | 7.8 | 2.72 | YES | 111 |
| Example 1 | | | | | | |
| Comparative | 165 | 68% | 2.3 | 2.75 | NO | 101 |
| Example 2 | | | | | | |
| Comparative | 151 | 4% | 8 | 2.78 | NO | 114 |
| Example 3 | | | | | | |
| Comparative | 150 | 29% | 6.8 | 2.78 | NO | 107 |
| Example 4 | | | | | | |
| Comparative | 166 | 29% | 6.8 | 2.78 | NO | 106 |
| Example 5 | | | | | | |
| Comparative | 167 | 20% | 5 | 2.77 | NO | 98 |
| Example 6 | | | | | | |
| Comparative | 125 | 65% | 7.8 | 2.72 | YES | 90 |
| Example 7 | | | | | | |
| Comparative | 179 | 30% | 8.6 | 2.81 | NO | 106 |
| Example 8 | | | | | | |
| Example 1 | 154 | 29% | 7.5 | 2.75 | NO | 135 |
| Example 2 | 145 | 29% | 7.6 | 2.77 | NO | 132 |
| Example 3 | 159 | 28% | 7.9 | 2.79 | NO | 134 |

TABLE 5

| | | Aligned | | | | Relaxation |
|---|---|---|---|---|---|---|
| | | Dendrite | | | | Resistance |
| | Average | Surface | Major Axis of | | Use of | (Remaining |
| | Hardness | Area Rate | Crystallized Si | Density ρ | Recycled | Stress) |
| Samples | HV | Adp | DsL (μm) | (g/cm³) | Mass | σr (Mpa) |
| Example 4 | 159 | 2% | 6.5 | 2.75 | NO | 144 |
| Example 5 | 144 | 2% | 6.5 | 2.75 | NO | 145 |
| Example 6 | 154 | 5% | 2.4 | 2.75 | NO | 151 |
| Example 7 | 158 | 7% | 6.5 | 2.75 | NO | 145 |
| Example 8 | 153 | 17% | 2.4 | 2.75 | NO | 143 |
| Comparative | 166 | 2% | 8.8 | 2.83 | NO | 128 |
| Example 9 | | | | | | |

TABLE 6

| | | Aligned | | | | Relaxation |
|---|---|---|---|---|---|---|
| | | Dendrite | Major Axis of | | | Resistance |
| | Average | Surface Area | Crystallized | | Use of | (Remaining |
| | Hardness | Rate | Si | Density ρ | Recycled | Stress) |
| Samples | HV | Adp | DsL (μm) | (g/cm³) | Mass | σr (Mpa) |
| Example 9 | 156 | 5% | 6.5 | 2.77 | YES | 137 |
| Comparative | 156 | 5% | 6.9 | 2.78 | YES | 118 |
| Example 10 | | | | | | |

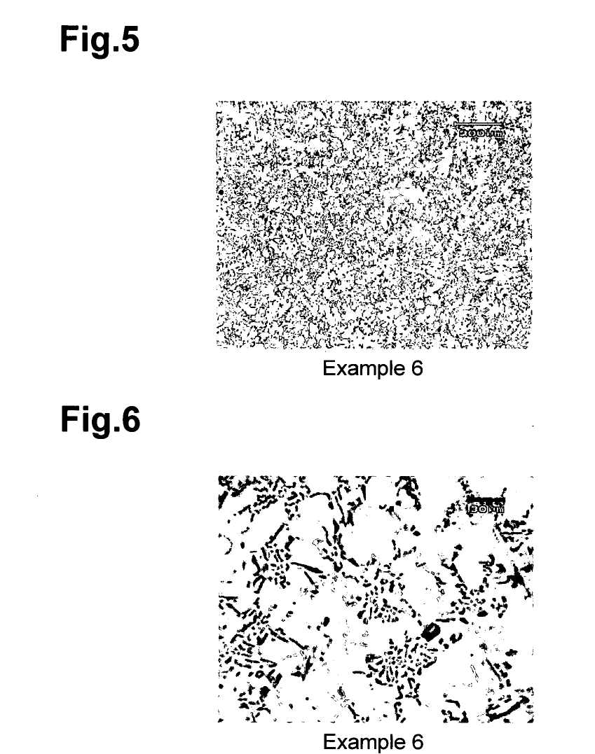

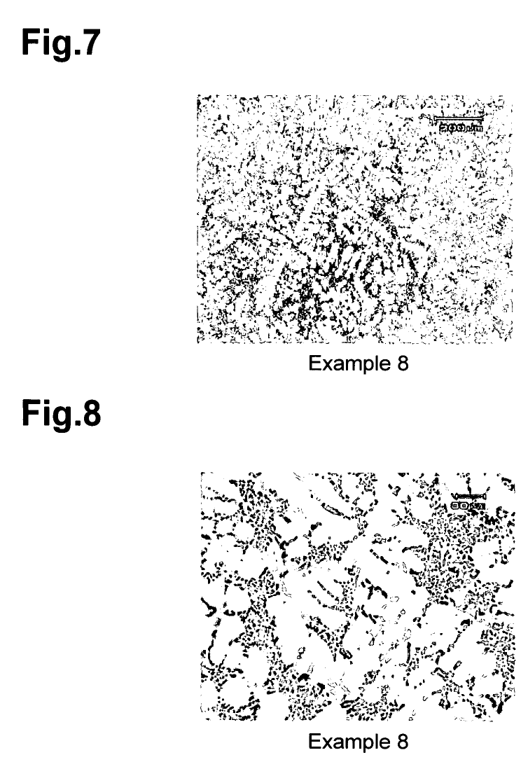

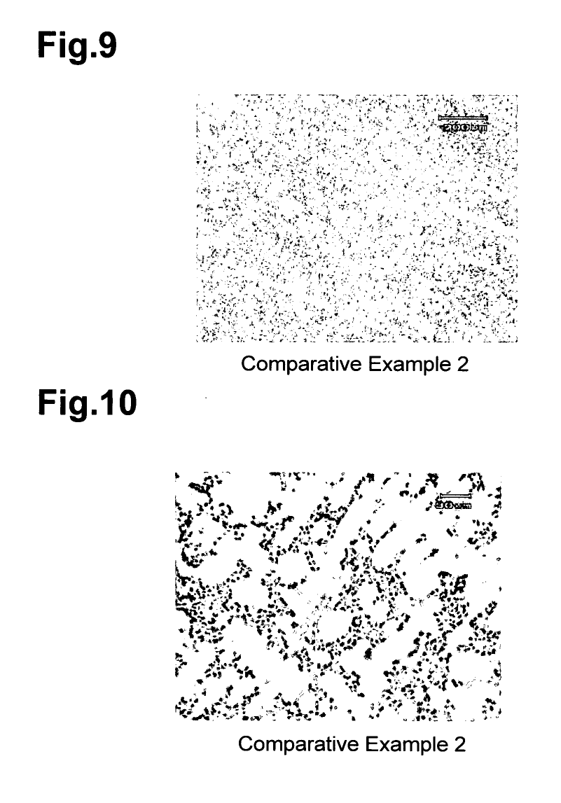

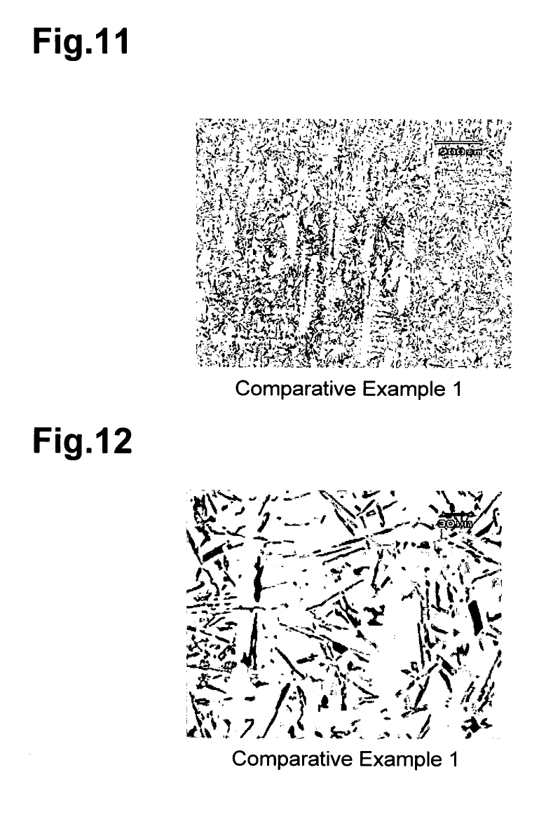

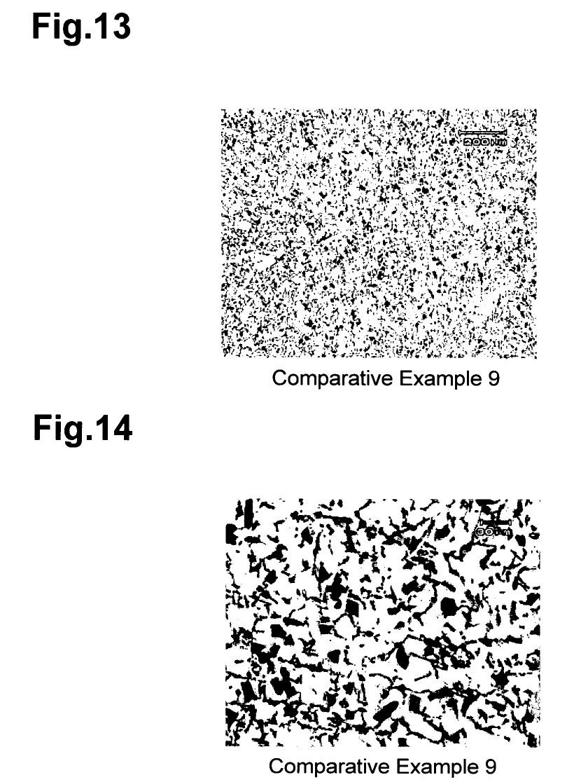

The micrographs of the metal structures of the typical ones of the above-described cast aluminum alloys are shown in FIGS. 5 to 14, for reference.

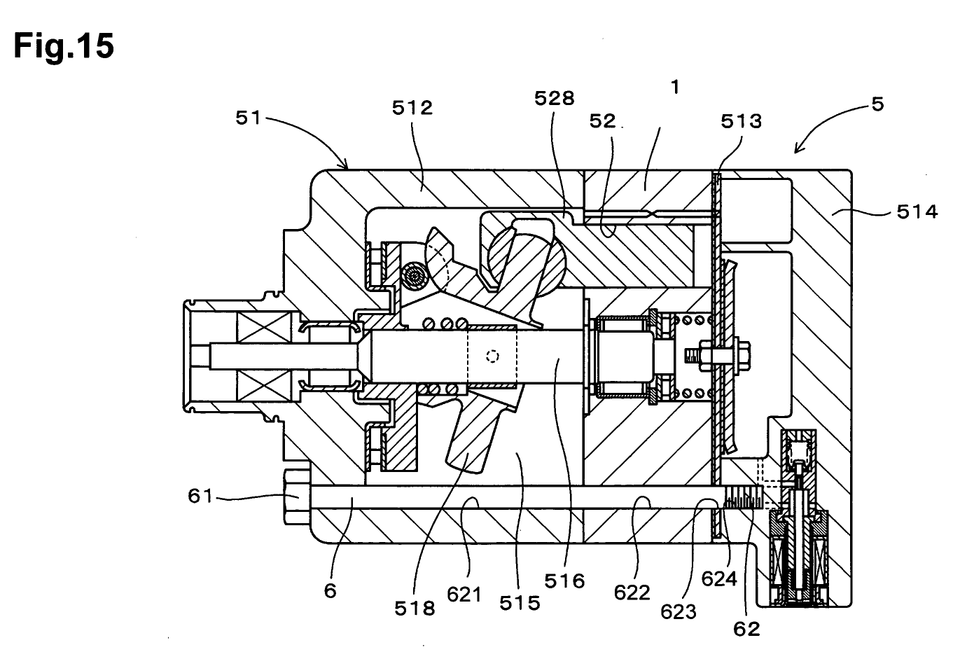

A compressor according to a second embodiment of the present invention will hereafter be explained with reference to FIG. 15.

As shown in FIG. 15, a compressor 5 according to the second embodiment has a housing 51, which is formed by a plurality of housing members 511, 512, 514 that are each formed of an aluminum alloy and connected together. The compressor 5 compresses refrigerant in the housing 51 and discharges the compressed refrigerant to the exterior.

In the second embodiment, three types of the alloys according to the first embodiment were used as the cast aluminum alloy forming the housing members 511, 512, and 514. The relaxation resistance of each of the housing members 511, 512, 514 was then evaluated.

First, the configuration of the compressor 5 will be explained briefly.

As shown in FIG. 15, the housing 51 of the compressor 5 includes a front housing member 512, a cylinder block 511, and a rear housing member 514. The three housing members are connected together sequentially. In other words, the front housing member 512 is joined with the front end of the cylinder block 511. The rear housing member 514 is fixed to the rear end of the cylinder block 511 through a valve plate assembly 513.

Coaxial through holes 621, 622, 623 are defined in the front housing member 512, the cylinder block 511, and the valve plate assembly 513. Also, a threaded hole 624 coaxial with the through holes 621 to 623 is defined in the rear housing member 514. A bolt 6 is passed through the through holes 621 to 623 and extends into the rear housing member 514. A threaded portion 62, which is formed at the distal end of the bolt 6, is engaged with the threaded hole 624. In this structure, the axial force produced by the bolt 6 is applied to contact portions of all of the housing members arranged between a head portion 61 of the bolt 6 and the threaded portion 62.

A crank chamber 515 is defined between the cylinder block 511 and the front housing member 512 in the housing 51. A drive shaft 516 and a swash plate 518 are received in the crank chamber 515. A piston 528 is accommodated and reciprocates in a cylinder bore 527 defined in the cylinder block 511. The components necessary for other functions of the compressor 5 are all accommodated in the housing 51. FIG. 15 shows an example of the configuration of the compressor 5 and such configuration and the internal structure of the compressor 5 may be modified in various publicly known forms.

As has been described, the compressor 5 includes the three housing members 511, 512, 514, each of which is formed of cast aluminum alloy. In the second embodiment, three housings 51 formed of the above-described three types of alloys were prepared. Each of the housing members was actually mounted in the compressor 5 and the relaxation resistance was evaluated in each of the housings 51.

A first compressor (hereinafter, referred to as sample E1) included three housing members formed of the alloy of Example 6 according to the first invention.

A second compressor (hereinafter, referred to as sample C1) included three housing members formed of the alloy of Comparative Example 7, which are conventional alloys.

A third compressor (hereinafter, referred to as sample C2) included three housing members formed of the alloy of Example 2, which are conventional alloys.

The sealing performance of each of the samples E1, C1, C2 was maintained by the axial force generated by the bolt 6, as has been described.

The housings of samples E1, C1, C2 were fastened together by equal initial axial force of bolts. The temperature of an oven (not shown) used for evaluation of the relaxation resistance was set to a maximum housing temperature in actual use of the compressor 5. The elastic extension amount and the axial force of each of the bolts 6 had been corrected in advance.

Each of the compressors 5 was maintained in the oven for a certain time. The compressor 5 was then removed from the oven and the length of the bolt 6 was measured when the temperature of the housing 51 reached 20° C. Afterwards, the compressor 5 was returned to the oven. These steps were repeatedly performed.

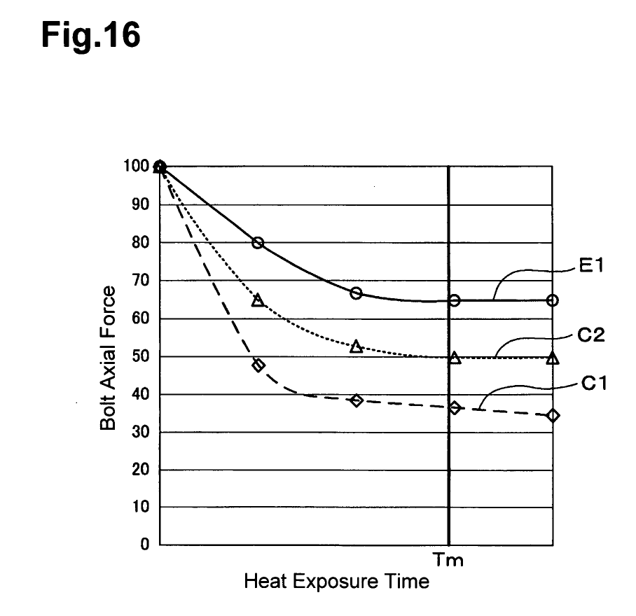

FIG. 16 represents changes of the bolt axial force as the time elapsed. In FIG. 16, the axis of abscissas represents the time of exposure to heat and the axis of ordinate represents the bolt axial force when the initial bolt axial force was defined as 100.

If carbon dioxide is used as refrigerant in this type of compressor, it is desirable that the bolt axial force be maintained at 60 or greater at the target time Tm.

As is clear from FIG. 16, sample E1 exhibits extremely improved relaxation resistance.

1. A compressor having a housing formed by a plurality of housing members each formed of an aluminum alloy, the compressor being configured in such a manner that a refrigerant is compressed in the housing and discharged to the exterior, wherein at least one of the housing members is formed of a cast aluminum alloy with an improved relaxation resistance, the cast aluminum alloy containing:
9 to 17 percent by mass of Si;
3.5 to 6 percent by mass of Cu;
0.2 to 1.2 percent by mass of Mg;
0.2 to 1.5 percent by mass of Fe;
0 to 1 percent by mass of Mn;
0.5 percent by mass or less of Ni; and
a remaining portion containing Al and unavoidable impurities.

2. The compressor according to claim 1, wherein the average hardness of the cast aluminum alloy is HV130 to HV170.

3. The compressor according to claim 1, wherein the average hardness of the cast aluminum alloy is adjusted, after the cast aluminum alloy is cast, through a solution heating in which the alloy is maintained at a treatment temperature of 450° C. to 510° C. for 0.5 hours or longer, followed by a water quenching, and then by an aging treatment in which the alloy is maintained at a treatment temperature of 170° C. to 230° C. for one to twenty-four hours.

4. The compressor according to claim 1, wherein the cast aluminum alloy contains 9 to 12 percent by mass of Si and has a hypoeutectic structure that does not contain primary crystal Si.

5. A compressor having a housing formed by a plurality of housing members each formed of an aluminum alloy, the compressor being configured in such a manner that a refrigerant is compressed in the housing and discharged to the exterior, wherein at least one of the housing members is formed of a cast aluminum alloy with an improved relaxation resistance, the cast aluminum containing:
9 to 17 percent by mass of Si;
3.5 to 6 percent by mass of Cu;
0.3 to 1.2 percent by mass of Mg;
0.1 to 1 percent by mass of Fe;
0.1 to 1 percent by mass of Mn;
0.15 to 0.3 percent by mass of Ti;
0.5 percent by mass or less of Ni; and
a remaining portion containing Al and unavoidable impurities.

6. The compressor according to claim 5, wherein the cast aluminum alloy further contains:
0.05 to 0.15 percent by mass of Zr; and
0.02 to 0.15 percent by mass of V.

7. The compressor according to claim 5, wherein the content of Si in the cast aluminum alloy is 9 to 12 percent by mass, and
wherein the cast aluminum alloy contains 0.001 percent by mass or less of P and has a hypoeutectic structure that does not contain primary crystal Si.

8. The compressor according to claim 7, wherein the cast aluminum alloy further contains at least one selected from the group consisting of:
0.0005 to 0.01 percent by mass of Ca;
0.0005 to 0.003 percent by mass of Na;
0.003 to 0.03 percent by mass of Sr; and
0.05 to 0.2 percent by mass of Sb.

9. The compressor according to claim 5, wherein the proportion of dendrite in which five or more dendrite cells are aligned substantially along one direction in the cast aluminum alloy is 20 percent or less by the surface area rate.

10. The compressor according to claim 9, wherein the cast aluminum alloy has an isotropic homogeneous structure substantially without alignment of the dendrite.

11. The compressor according to claim 9, wherein the density of the cast aluminum alloy is 2.8 g/cm³ or less.

12. The compressor according to claim 5, wherein the average hardness of the cast aluminum alloy is HV130 to HV170.

13. The compressor according to claim 5, wherein the average hardness of the cast aluminum alloy is adjusted, after the cast aluminum alloy is cast, through a solution heating in which the alloy is maintained at a treatment temperature of 450° C. to 510° C. for 0.5 hours or longer, followed by a water quenching, and then by an aging treatment in which the alloy is maintained at a treatment temperature of 170° C. to 230° C. for one to twenty-four hours.

14. The compressor according to claim 7, wherein the average major axis of crystallized Si of the cast aluminum alloy is 5 μm or less.

15. The compressor according to claim 1, wherein the cast aluminum alloy further contains at least one selected from the group consisting of:
0.01 to 0.1 percent by mass of Sn;
0.02 to 0.15 percent by mass of Pb; and
0.1 to 1 percent by mass of Zn.

16. The compressor according to claim 1, wherein the Si content in a base Al phase of the cast aluminum alloy is 0.95 percent by mass or greater.

17. The compressor according to claim 1, wherein the housing members are fastened together using a bolt formed of steel.

18. The compressor according to claim 17, wherein the housing includes a sealing structure that generates surface pressure in a contact portion of the housing members through axial force generated by the bolt and thus prevents the refrigerant from leaking from the interior of the housing.

19. The compressor according to claim 1, wherein the refrigerant is carbon dioxide.
